(19) United States
(12) Patent Application Publication
(10) Pub. No.: US 2007/0065608 A1
(43) Pub. Date: Mar. 22, 2007

(54) Metal containers having an easily openable end and method of manufacturing the same

(75) Inventor: Jeffrey Niederst, Pittsburgh, PA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: VALSPAR SOURCING, INC., Minneapolis, MN (US)

(21) Appl. No.: 10/564,900

(22) PCT Filed: Jul. 12, 2004
(86) PCT No.: PCT/US04/22382

§ 371 Date: Jul. 21, 2006

Related U.S. Application Data
(60) Provisional application No. 60/490,475, filed on Jul. 28, 2003.

(51) Int. Cl. C08F 2/46; C08J 7/18; B05D 3/02; B31B 45/00

(52) U.S. Cl. 428/34.1; 427/487; 427/384

(57) ABSTRACT

An improved easily openable end for a metal container, and aL method of manufacturing the end are disclosed. The metal container is manufactured from a can body and two can ends, one of which is easily openable. The easily openable can end is manufactured from a metal substrate having a score line on its external surface that permits easy removal of at least a portion of the can end from the can body. The score line of the easily openable can end is coated with a iradiation-curable coating composition that impa˜ts corrosion resistance along the score line of the easily openable can end.

### FIELD OF THE INVENTION

The present invention relates to metal containers having an easily openable metal end. More particularly, the present invention relates to an easily openable metal end having a score line on its exterior surface, wherein the score line has a radiation-cured coating applied thereon. The radiation-cured coating imparts corrosion resistance to the score line of the can end during product processing and storage.

### BACKGROUND OF THE INVENTION

Easily openable metal ends are widely used as the closure of metal containers because the container can be opened without using a can opener or similar tool. Easily openable metal ends have score lines (i.e., guide lines for opening) which permit tearing of the end from the container body to provide an opening for removing the contents from the container. Easily openable can ends typically are used in metal beverage containers, general food containers, and the like.

An easily openable can end is manufactured from a sheet of a metal substrate, such as aluminum, tin-plated steel, or tin-free steel. The metal sheet has a cured protective coating on each major surface. The cured protective coating can be the same on each major surface or different. The protective coating used for the surface of the metal sheet that forms the internal surface of the can end is judiciously selected after considering the contents of the container that will contact the internal surface of the can end.

The protective coating on the surface of the metal sheet that forms the exterior surface of the can end can be any coating material that protects the exterior of the can end from corrosion, either during processing of the product packaged in the can, e.g., during retort, or during storage of the packaged product. The exterior coating can be, for example, a cured composition containing a cross-linkable epoxy compound and a urea-formaldehyde resin.

The can end is formed from the metal sheet by punching out a metal form that corresponds to the desired shape and dimensions of the can end. Next, a score that corresponds to the easily openable dimensions of the can lid is made in the metal form. This scoring process penetrates the metal form well into the thickness of the metal (e.g., about ½ to about ⅔ of the metal thickness), and, accordingly, destroys the integrity of the protective coating on the exterior surface of the can end along the score line. Typically, a repair coating is applied to the score line to restore the protective coating.

A scored can end is more fully illustrated in FIG. 1. In particular, FIG. 1 illustrates a sectional view of an easily openable can end 1. The uppermost surface 8 of can end 1 is the exterior of the can end, and the lowermost surface 9 is the interior of the can end. Can end 1 comprises a metal substrate 2 and one or more protective coating layers 3, 4, and 5 provided on the internal surface of metal substrate 2. A protective coating 6 is formed on the exterior surface of metal substrate 2, and score line 7 is provided to extend from the external surface of can end 1 into the thickness of metal substrate 2. The score line 7 renders can end 1 easily openable.

As shown in FIG. 1, the exterior coating 6 of can end 1 is disrupted along score line 7, and exposes surfaces of metal substrate 2 to the atmosphere. These bare surfaces of metal substrate 2 are readily susceptible to corrosion during processing of the product packaged in the can or during product storage.

The bare metal surfaces of substrate 2 defined by score line 7 have been coated with various compositions in an attempt to impart corrosion resistance along score line 7. These compositions, termed repair coatings, have demonstrated disadvantages such that complete corrosion resistance along score line 7 has not been achieved.

For example, a wax-based composition has been applied to the score line of an easily openable can end. Such compositions do not completely resist corrosion at the score line in cases wherein a filled and sealed container is subjected to retort conditions. In these cases, the retort conditions (e.g., about 110° C. to about 130° C. for about 60 to about 120 minutes) can melt the protective wax-based composition and expose portions of bare metal along the score line. Other compositions contain a high percent of solvents (e.g., 70% to 80%, by weight), which is cost ineffective and leads to the generation of excessive amounts of solvent vapor during cure. Another disadvantage associated with present-day repair coatings is an inability to uniformly coat the score line, and thereby leave substantial portions of the score line unprotected.

### SUMMARY OF THE INVENTION

The present invention is directed to improved compositions and methods of coating a score line of an easily openable can end to impart essentially complete corrosion resistance to the score line during processing and storage of a packaged product. The present invention also is directed to metal containers having an easily openable can end, wherein corrosion along the score line of the exterior surface of the can end is essentially completely eliminated. More particularly, the present invention is directed to a corrosion-resistant metal can end, its method of preparation, and to radiation-curable coating compositions, e.g., ultraviolet (UV)-curable, for application to the score line of an easily openable can end. After curing, the radiation-curable coating composition imparts essentially complete corrosion resistance to the score line during processing and storage of a filled metal container.

Accordingly, one aspect of the present invention is to provide an easily openable can end of a metal container, said end having a repair coating composition applied uniformly to the score line of the can end, followed by radiation curing and an optional heating step, to essentially eliminate corrosion along the score line of the easily openable can end during processing and storage of a filled metal container.

Another aspect of the present invention is to provide a method of preparing a corrosion-resistant, easily openable metal can end comprising:

(a) providing a metal end having a score line;

(b) applying a radiation-curable coating composition to the score line to provide a coated metal can end;

(c) subjecting the coated metal can end to a sufficient dose of radiation, e.g., ultraviolet radiation, infrared radiation, or e-beam radiation, to provide a tack-free coating composition on the coated metal can end; and

(d) optionally heating the can end of step (c) at a sufficient temperature and for a sufficient time to complete curing of the radiation-curable coating composition.

Yet another aspect of the present invention is to provide a radiation-curable coating composition suitable for application to the score line of an easily openable can end to render the score line corrosion resistant. The radiation-curable coating composition contains about 70% to 100%, by weight, of nonvolatile materials. The volatile material can be water, an organic solvent, or a mixture thereof. Therefore, the release of toxic and environmentally unfriendly solvents can be eliminated, or at least substantially reduced, during radiation curing of the coating composition.

Another aspect of the present invention is to provide a radiation-curable coating composition for application to the score line of an easily openable can end, said coating composition comprising: (a) about 60% to about 85%, by weights, of a difunctional compound containing epoxy and/or vinyl groups, (b) about 10% to about 20%, by weight, of a polyfunctional reactive diluent, (c) about 2% to about 8%, by weight, of a photoinitiator, e.g., a cationic photoinitiator, and (d) 0% to about 12%, by weight, of a monofunctional reactive diluent. The radiation-curable coating composition, optionally, also can contain a surfactant, an optical brightener, and other optional ingredients known to persons skilled in the art. In most preferred embodiments, the difunctional compound comprises an epoxy group, and most preferably comprises a cycloaliphatic diepoxy compound.

Yet another aspect of the present invention is to provide a method of essentially completely eliminating corrosion at the score line of an easily openable can end by applying a radiation-curable coating composition comprising (a) about 60% to about 85%, by weight, of a difunctional compound containing epoxy and/or vinyl groups, (b) about 10% to about 20%, by weight, of a polyfunctional reactive diluent, (c) about 2% to about 8%, by weight, of a photoinitiator, and (d) 0% to about 12%, by weight, of a monofunctional reactive diluent, to the score line, then curing the coating composition by applying a sufficient dose of radiation to cure the coating to at least a tack-free state and, optionally, then heating the cured coating composition to complete curing of the composition.

The cured coating composition effectively inhibits corrosion of ferrous and nonferrous metal substrates when the composition is applied as a repair coating to the score line of a metal can end, then radiation cured for a sufficient time to provide a tack-free crosslinked coating. If necessary, the tack-free coating can be subjected to a heating step at a sufficient temperature and for a sufficient time to fully cure the coating composition. A cured and crosslinked coating composition demonstrates sufficient chemical and physical properties for use as a repair coating on a score line on the exterior of an easily openable metal can end.

As used here and hereafter, the term “radiation-curable coating composition” is defined as a composition including the difunctional compound, polyfunctional reactive diluent, photoinitiator, optional monofunctional reactive diluent, and any other optional ingredients, optionally dispersed in an aqueous or nonaqueous carrier. The term “cured coating composition” is defined as the adherent, tack-free polymeric coating resulting from curing a radiation-curable coating composition. The cured coating composition comprises the difunctional compound, polyfunctional reactive diluent, and mono-functional diluent, essentially in the amounts these ingredients are present in the radiation-curable coating composition, expressed as nonvolatile material. The term “tack free” is defined as a partially or completely cured coating composition that does not adhere to skin or deform when touched.

These and other aspects and advantages of the present invention will become apparent from the following detailed description of the preferred embodiments.

### BRIEF DESCRIPTION OF THE DRAWINGS

FIG. 1 is a cross-sectional view showing an easily openable closure.

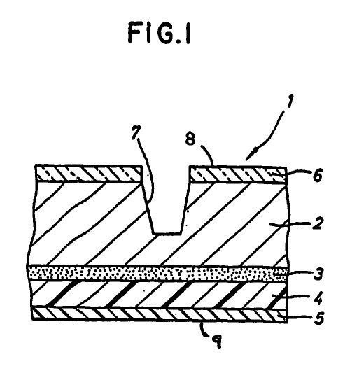

### DETAILED DESCRIPTION OF THE PREFERRED EMBODIMENTS

An improved easily openable metal can end of the present invention has a radiation-curable coating composition applied to a score line to serve as a repair coating. In one embodiment a radiation-curable coating composition utilized in the present invention comprises (a) about 60% to about 85%, by weight, of a difunctional compound containing epoxy and/or vinyl groups, (b) about 10% to about 20%, by weight, of a polyfunctional reactive diluent, (c) about 2% to about 8%, by weight, of a photoinitiator, (d) 0% to about 12%, by weight, of a monofunctional reactive diluent, and (e) 0% to about 10%, by weight, of optional ingredients. The radiation-curable coating composition contains about 70% to 100%, by weight, of nonvolatile materials, and 0% to about 20%, by weight of water, an organic solvent, or mixture thereof.

In another embodiment, the radiation-curable coating composition contains about 60% to about 85%, and preferably about 65% to about 80%, by weight, of the difunctional compound. To achieve the full advantage of the present invention, the radiation-curable coating composition contains about 70% to about 80%, by weight, of the difunctional compound.

A difunctional compound utilized in the radiation-curable coating composition is a monomer, dimer, oligomer, or mixture thereof. The identity of the difunctional epoxy compound is not limited, as long as the difunctional compound contains two epoxy groups, two vinyl groups, or one epoxy group and one vinyl group.

Typically, the difunctional compound has a weight average molecular weight (M_{w}) of about 5000 or less, and preferably about 3000 or less, e.g., about 100 to about 2000. High molecular weight resins and polymers are less preferred because the viscosity of the radiation-curable composition can become too great for homogeneous application of the composition to the score line.

Suitable difunctional compounds can be (a) a compound having two epoxy groups, i.e., a diepoxy compound, (b) a compound having a vinyl group and an epoxy group, i.e., a vinyl epoxy, (c) a compound having two vinyl groups, e.g., a divinyl ether, or (d) a mixture thereof. In preferred embodiments, the difunctional compound comprises a diepoxy compound.

Suitable diepoxy compounds include aliphatic diepoxy compounds, aromatic diepoxy compounds, or a mixture thereof. In preferred embodiments, the diepoxy compound comprises an aliphatic diepoxy compound, and particularly, a cycloaliphatic diepoxy compound. In more preferred embodiments, the diepoxy compound is essentially free of an aromatic diepoxy compound, i.e., the composition contains 0% to about 10%, by weight, of an aromatic diepoxy compound.

Suitable diepoxy compounds useful in the present invention include, but are not limited to, low molecular weight diepoxy compounds derived from bisphenols, such as bisphenol A, and epihalohydrins. Such diepoxy compounds have a general structural formula

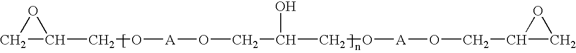

wherein A represents a condensation residue of divalent aromatic hydrocarbon group derived from a dihydric phenol or diol. Preferably, the diepoxy compound has an epoxy equivalent weight (EEW) of about 2500 or less. More particularly, the diepoxy compounds can be a condensation product of an epihalohydrin and bisphenol A (i.e., (2,2′-bis(4-hydroxyphenyl)propane) and having an average M_{w} of about 2000 or less.

The dihydric phenol utilized in the above diepoxy compound can be, for example, bisphenol A, bisphenol F, 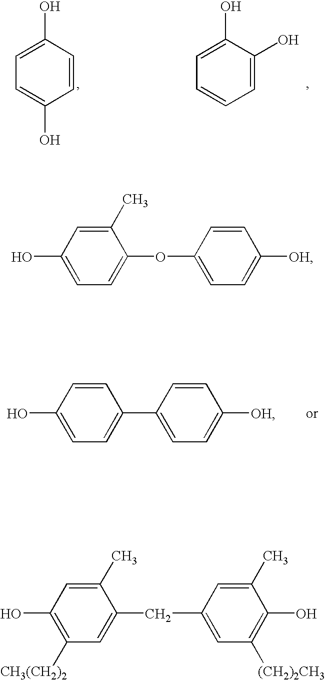
Examples of useful aromatic diepoxy compounds include, but are not limited to, D.E.R. 736, EPON 828, EPON 1004, EPON 1007, and EPON 1009, all available from Dow Chemical Co., Midland, Mich.

Other useful, and preferred, cycloaliphatic diepoxy compounds are 3,4-epoxycyclohexylmethyl-3,4-epoxycyclohexane carboxylate, bis(3,4-epoxycyclohexyl)methyladipate, and mixtures thereof. These diepoxy compounds are available commercially as CYRACURE® UVR-6110 and UVR-6128, from Union Carbide Corp., Danbury, Conn., having the structural formulae

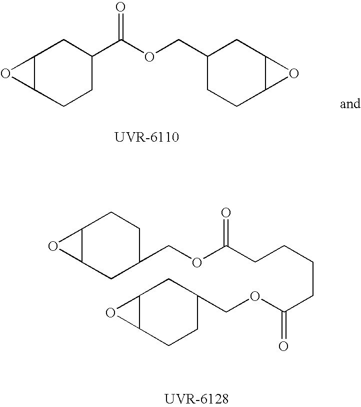

Additional diepoxy compounds include, but are not limited to, 2-(3,4-epoxycyclohexyl-5.5-spiro-3,4-epoxy)cyclohexane-metal-dioxane, 1,6-hexanediol diglycidyl ether, dipropylene glycol diglycidyl ether, diglycidyl ether of polypropylene glycol, ethylene glycol diglycidyl ether, a diglycidyl ether of phthalic acid, a diglycidyl ether of hexahydrophthalic acid, propylene glycol dioleate epoxide, limonene dioxide, a cresol-novolac diepoxy compound, 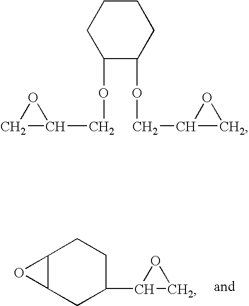
other diepoxy compounds, and mixtures thereof.

The diepoxy compound also can be a silicone-containing compound, such as UV9400, UV9315, and UV500A, available from GE Silicones, Waterford, N.Y. UV9400, UV9315, and UV500A contain 80-99%, by weight, of dimethyl methyl, 2-(7-oxabicyclo(4.1.0)-hept-3-yl)ethyl silicone having (dimethyl(2-(7-oxabicyclo(4.1.0)hept-3-yl)ethylsilyl)-oxy) terminal groups. The epoxysilicone in UV9400, UV9315, and UV500A has a CAS No. 150678-61-8. UV9300 is another suitable epoxysilicone (containing 80-99%, by weight, dimethyl, methyl, 2 (7-oxabicyclo(4.1.0)help-3-yl)ethyl)silicone (CAS No. 67762-95-2), also available from GE Silicones.

An additional epoxy-functional silicone available from the GE Silicones is UV9320 containing 80-99%, by weight, (2-hydroxyphenyl)propyl, trimethyl-heptyl-3-yl)ethyl, methyl-3-methyl-2-(7-oxabicyclo(4.10)hept-3-yl)ethylsilyl)oxy)silicone having dimethyl siloxy terminal groups (CAS No. 13-885-21-1). Additional epoxysilicone compounds are disclosed in Koshar et al. U.S. Pat. No. 4,313,988, incorporated herein by reference.

The difunctional compound also can be a vinyl epoxy compound having a structural formula 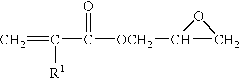
wherein R¹ is hydrogen or methyl.

In addition to the above (meth)acrylate epoxy compounds, the vinyl epoxy compounds can be any compound having a carbon-carbon double bond and a glycidyl group. Typically, the monomer is a glycidyl ester of an α,β-unsaturated acid, or anhydride thereof. The α,β-unsaturated acid can be a monocarboxylic acid or a dicarboxylic acid. Examples of such carboxylic acids include, but are not limited to, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbic acid, α-chlorosorbic acid, angelic acid, cinnamic acid, p-chlorocinnamic acid, β-stearylacrylic acid, itaconic acid, citraconic acid, mesaconic acid, glutaconic acid, aconitic acid, maleic acid, fumaric acid, tricarboxyethylene, maleic anhydride, and mixtures thereof.

Specific examples of vinyl epoxy compounds include, but are not limited to, glycidyl(meth)-acrylate (i.e., glycidyl methacrylate and glycidyl acrylate), mono- and diglycidyl itaconate, mono- and diglycidyl maleate, and mono- and diglycidyl fumarate. It also is envisioned that allyl glycidyl ether and vinyl glycidyl ether can be used as the difunctional epoxy compound.

The difunctional compound also can be a divinyl compound, and in preferred embodiments a divinyl ether. Nonlimiting examples of divinyl compounds useful in the present invention are divinyl ether, diethylene glycol divinyl ether, 1,4-butanediol divinyl ether, triethylene glycol divinyl ether, and 1,4-cyclohexanedimethanol divinyl ether.

In addition to the difunctional compound, the radiation-curable coating composition contains a polyfunctional reactive diluent. The polyfunctional reactive diluent preferably is present in an amount of about 10% to about 20%, and more preferably about 12% to about 18%, by weight, of the composition.

The polyfunctional reactive diluent reduces the viscosity of the radiation-curable composition, and facilitates application of the composition to a score line. The polyfunctional reactive diluent also reacts with the difunctional compound to form a crosslinked repair coating on the score line.

The polyfunctional reactive diluent is any compound having at least two functional groups capable of reacting with an epoxy or vinyl group of the difunctional compound, and forming a crosslinked polymer with the difunctional compound. The polyfunctional reactive diluent typically comprises a polyol, and preferably a triol.

Nonlimiting examples of the polyfunctional reactive diluent include hydroxy-terminated polyols, and preferably ε-caprolactone triols, such as the trifunctional polyols TONE® 0301, 0305, and 0310, all available from Union Carbide Corp., Danbury, Conn. Other useful polyfunctional reactive diluents include glycerol, a polyether polyol, a polyester polyol, 1,2,6-hexanetriol, pentaerythritol, and other triols known to persons skilled in the art. The polyfunctional reactive diluents can be used alone or in admixture.

The radiation-curable coating composition also contains a photoinitiator. The photoinitiator preferably is present in an amount of about 2% to about 8%, and more preferably about 2% to about 7%, by weight, of the composition. To achieve the full advantage of the present invention, the photoinitiator is present in an amount of about 3% to about 6%, by weight, of the composition.

For UV- and e-beam-curable compositions, the photoinitiator preferably is a cationic photoinitiator. For infrared (IR)-curable compositions, the photoinitiator preferably is a thermally-blocked acid catalyst.

For UV- and e-beam-radiation curing, the photoinitiator can be any initiator used in a UV- or e-beam-curing application. In particular, a cationic initiator is preferred, and can be a sulfonium salt, an iodonium salt, or a mixture thereof. The anion of these salts is not limited, but preferably is a complex anion containing Group Va or VIa elements. Exemplary, but nonlimiting, elements present in the anions are, for example, boron, phosphorus, antimony, arsenic, and tin. Nonlimiting examples of suitable anions include, but are not limited to, BF₄⁻, PF₆⁻, AsF₆⁻, SbF₆⁻, SnCl₆⁻, SbCl₆⁻, BiCl₅⁻², ClO₄⁻, HSO₄⁻, ZrF₆⁻², GaCl₄⁻, InF₄⁻, TiF₆⁻, Alf₆⁻, and FeCl₄⁻².

Nonlimiting examples of specific sulfonium salt photoinitiators include the triaryl sulfonium complex salts, such as phenoxyphenyl sulfonium hexafluorophosphate, trifluoromethyl diphenyl sulfonium tetrafluoroborate, triphenyl sulfonium tetrafluoroborate, methyl diphenyl sulfonium tetrafluoroborate, dimethyl phenyl sulfonium hexafluoroborate, triphenyl sulfonium hexafluorophosphate, triphenyl sulfonium hexafluoroantimonate, diphenyl naphthyl sulfonium hexafluoroarsenate, tritolyl sulfonium hexafluorophosphate, anisyl diphenyl sulfonium hexafluoroantimonate, 4-butoxyphenyl diphenyl sulfonium tetrafluoroborate, 4-chlorophenyl diphenyl sulfonium hexafluorophosphate, tri(4-phenoxyphenyl)sulfonium hexafluorophosphate, di(4-ethoxyphenyl)methyl sulfonium hexafluoroarsenate, 4-acetonylphenyl diphenyl sulfonium tetrafluoroborate, 4-thiomethoxyphenyl diphenyl sulfonium hexafluorophosphate, di(methoxysulfonylphenyl)methyl sulfonium hexafluoroantimonate, di(nitrophenyl)phenyl sulfonium hexafluoroantimonate, di(carbomethoxyphenyl)methyl sulfonium hexafluorophosphate, 4-acetamidophenyl diphenyl sulfonium tetrafluoroborate, p-(phenylthiophenyl)diphenyl sulfonium hexafluoroantimonate, 10-methyl phenoxathiinium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 5-methyl-10-oxothianthrenium tetrafluoroborate, 5-methyl-10,10-dioxothanthrenium hexafluorophosphate, dimethyl naphthyl sulfonium hexafluorophosphate, and mixtures thereof. Bis-type sulfonium salt photoinitiators, for example, bis-(4-(diphenylsulfonio)phenyl)sulfide bis-hexafluorophosphate, also can be used.

Many sulfonium salt photoinitiators are available commercially. For example, a suitable sulfonium salt initiator is available under the trade name CYRACURE® UVI-6974 from Union Carbide Corporation, of Danbury, Conn. CYRACURE® UVI-6974 contains a mixture of (thiodi-4,1-phenylene)bis-(diphenyl-sulfonium)hexafluoroantimonate and diphenyl(4-phenylthiophenyl)sulfonium hexafluoroantimonate, and is sold as a 50 wt % solution in propylene carbonate.

Preferred sulfonium salt initiators are CYRACURE® UVI-6976 and UVI-6992, i.e., mixed triarylsulfonium hexafluoroantimonate salts and mixed triarylsulfonium hexafluorophosphate salts, respectively, having the structures: 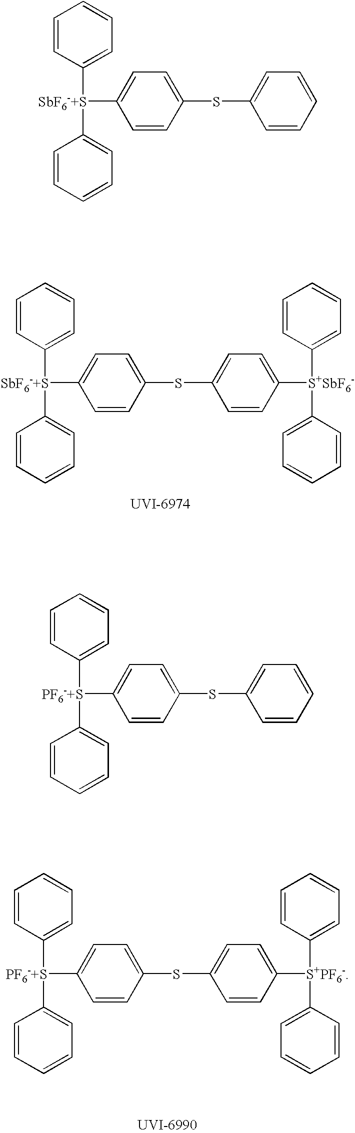
Another preferred sulfonium photoinitiator available from Union Carbide Corporation is CYRACURE® UVI-6990. UVI-6990 contains bis(4-(diphenylsulfonio)phenyl)sulfide bis(hexafluorophosphate) and diphenyl phenylthiophenyl sulfonium hexafluorophosphate, and is sold as a 50% solution in propylene carbonate.

Nonlimiting examples of useful iodonium salt initiators include the aryl iodonium salts, such as diphenyliodoniuim tetrafluoroborate, di(2,4-dichlorophenyl)iodonium hexafluorophosphate, diphenyliodonium hexafluorophosphate, diphenyliodonium hexafluoroarsenate, diphenyliodonium iodide, diphenyliodonium hexafluoroantimonate, 4-chlorophenylphenyliodonium tetrafluoroborate, di(4-chlorophenyl)iodonium hexafluoroantimonate, diphenyliodonium hexafluorophosphate, diphenyliodonium trifluoroacetate, 4-trifluoromethylphenylphenyliodonium tetrafluoroborate, ditolyliodonium hexafluorophosphate, di(4-methoxyphenyl)iodonium hexafluoroantimonate, di(4-methoxyphenyl)iodonium chloride, (4-methylphenyl)phenyliodonium tetrafluoroborate, di(2,4-dimethylphenyl)iodonium hexafluoroantimonate, di(4-t-butylphenyl)iodonium hexafluoroantimonate, 2,2′-diphenyliodonium hexafluorophosphate, di(4-methylphenyl)iodonium tetrafluoroborate, di(4-heptylphenyl)iodonium tetrafluoroborate, di(3-nitrophenyl)iodonium hexafluorophosphate, di(4-chlorophenyl)-iodonium hexafluorophosphate, di(naphthyl)iodonium tetrafluoroborate, di(4-trifluoromethylphenyl)-iodonium tetrafluoroborate, di(4-methylphenyl)-iodonium hexafluorophosphate, diphenyliodonium hexafluoroarsenate, di(4-phenoxyphenyl)iodonium tetrafluoroborate, diphenyliodonium hexachlorostannate, phenyl-2-thienyliodonium hexafluorophosphate, diphenyliodonium hexafluorostannate, 2,2′-diphenyliodonium tetrafluoroborate, di(2,4-dichlorophenyl)-iodonium hexafluorophosphate, di(4-bromophenyl)-iodonium hexafluorophosphate, di(4-methoxyphenyl)-iodonium hexafluorophosphate, di(3-carboxyphenyl)-iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzotienyl)iodonium hexafluorophosphate, bis(4-dodecylphenyl)iodonium hexafluoroantimonate, bis(4-dodecylphenyl)iodonium hexafluoroarsenate, and mixtures thereof.

Many iodonium salt initiators are available commercially. One iodonium salt is available from the General Electric Co., Waterford, N.Y. under the trade designation UV9380C. UV9380C contains about 30% to about 60%, by weight, bis(4-dodecylphenyl)iodonium hexafluoroantimonate. Other components of UV9380C are 2-isopropyl thioxanthone, C₁₂ and C₁₄ alkylglycidyl ethers (about 30% to about 60% by weight), and linear alkylate dodecylbenzene. The C₁₂ and C₁₄ alkylglycidyl ethers are monoepoxy compounds and can be considered as included in the monofunctional diluent component of the composition.

Another useful iodonium salt is available from the General Electric Co. under the trade designation UV9310C. The active initiator component of UV9310C is about 30 to about 60 weight percent bis-(4-dodecylphenyl)iodonium hexafluoroantimonate. Other components of UV9310C are 2-ethyl-1,3-hexanediol (about 30-60 weight percent) and a linear alkylate dodecylbenzene (about 5-10 weight percent). The 2-ethyl-1,3-hexanediol present in UV9310C is a polyhydroxy compound capable of reacting with the epoxy functionalities and can be considered as included in the polyfunctional reactive diluent component of the composition.

Other examples of sulfonium salt and iodonium salt photoinitiators are found, for example, in Guarnery et al. U.S. Pat. No. 4,250,006; Schlesinger U.S. Pat. No. 4,287,228; and Smith U.S. Pat. No. 4,250,053, each incorporated herein by reference.

For IR-cured coating compositions, thermally-blocked acid catalysts are preferred. When subjected to heat, the thermally blocked acid catalysts decompose to liberate the active photoinitiator. Examples of thermally blocked acid catalysts include the NACURE® catalysts, available from King Industries, Norwalk, Conn. The released acid catalysts typically are sulfonic acids, but also can be a phosphate. Specific examples of a photoinitiator released by the application of heat to the thermally-blocked acid catalysts include, but are not limited to, para-toluene sulfonic acid, dinonylnaphthalene disulfonic acid, dinonylnaphthalene monosulfonic acid, and dodecylbenzene sulfonic acid.

An optional component of the radiation-curable coating composition is a monofunctional reactive diluent. The monofunctional reactive diluent can be an alcohol; an epoxy compound, a glycol ether, or a mixture thereof. The monofunctional reactive diluent contains one moiety capable of reacting with an epoxy group of the difunctional epoxy compound, e.g., an alcohol, or one moiety capable reacting with a hydroxy group of the polyfunctional reactive diluent, e.g., an epoxy compound. The monofunctional reactive diluent reduces the viscosity of the UV-curable coating composition, and imparts flexibility to the cured composition.

The monofunctional reactive diluent preferably is present in the radiation-curable coating composition in an amount of 0% to about 12%, and more preferably about 2% to about 10%, by weight, of the composition. To achieve the full advantage of the present invention, the monofunctional diluent is present in an amount of about 2% to about 8%, by weight, of the composition. In preferred embodiments, the composition contains an alcohol and an epoxy as monofunctional reactive diluents.

Examples of suitable epoxy compounds useful as the monofunctional reactive diluent include, but are not limited to, epoxidized C₁₀ to C₃₀ alpha olefins, particularly epoxidized C₁₀, C₁₂, C₁₄, C₁₆, and C₁₈ alpha olefins, such as 1,2-epoxyhexadecane, 1,2-epoxydecane, and 1,2-epoxytetradecane; alpha pinene oxide; limonene monoxide; epoxidized polybutene; mixed cycloaliphatic monoepoxides (e.g., CYRACURE® UVR-6100 and UVR-6216, available from Union Carbide), and mixtures thereof.

Examples of suitable alcohols useful as the monofunctional reactive diluent include, but are not limited to, butanol, n-propanol, hexanol, octanol, diacetone alcohol, and mixtures thereof. Glycol ethers also can be used as the monofunctional reactive diluent. Useful glycol ethers include, but are not limited to, ethylene glycol monomethyl ether, ethylene glycol monoethyl ether, ethylene glycol monobutyl ether, propylene glycol monomethyl ether, and mixtures thereof.

The radiation-curable coating composition also can include other optional ingredients that do not adversely affect the radiation-curable coating composition or a cured coating composition resulting therefrom. Such optional ingredients are known in the art, and are included in a radiation-curable coating composition to enhance composition esthetics, to facilitate manufacturing and application of the radiation-curable coating composition, and to further improve a particular functional property of a radiation-curable coating composition or cured coating composition resulting therefrom.

The optional ingredients are present in the radiation-curable-coating composition in an amount of 0% to about 10% in total, and, individually, in an amount of about 0% to about 2%, by weight, of the composition. In general, each optional ingredient is included in a sufficient amount to serve its intended purpose, but not in such an amount to adversely affect a radiation-curable coating composition or a cured coating composition resulting therefrom.

For example, a surfactant, and typically a silicone surfactant, is included in the composition in an amount of 0% to about 0.5%, by weight, of the composition. Examples of useful silicone surfactants include SILWET L-7604 or L-7500, available from WITCO Corp., NY, N.Y.

Another optional ingredient of the radiation-curable coating composition is an optical brightener, present in an amount of 0% to about 0.05%, by weight, of the composition. The optical brightener is useful in quality control of the easily openable can ends to determine whether the radiation-curable coating composition homogeneously covers the score line. An example of a useful optical brightener is UVITEX® DB, having a structural formula 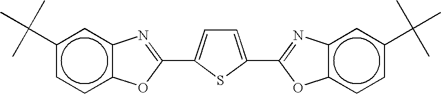
Other optical brighteners known to persons skilled in the art also can be used in the radiation-curable coating composition, alone or in admixture.

Other optional ingredients include, but are not limited to, dyes, pigments, additional anticorrosion agents, antioxidants, adhesion promoters, light stabilizers, a viscosity reducer (e.g., a solvent), slip and mar resistance additives (e.g., a silicon fluid, like DC-57, available from Dow Corning Corp., Midland, Mich.), and mixtures thereof.

In accordance with an important feature of the present invention, the radiation-curable coating composition can be free of solvents, i.e., having no (0%) volatile organic content (VOC). A composition having a low VOC is important with respect to meeting environmental regulations and protecting workers in manufacturing plants from the effects of organic solvent vapors.

If desired, a radiation-curable coating composition of the present invention can contain up to 30%, by weight, of an aqueous or an organic solvent. In some cases, a solvent is useful to reduce the viscosity of the UV-curable coating composition, which facilitates application of the radiation-curable coating composition to the score line of the can end. The solvent has sufficient volatility to evaporate essentially entirely from the coating composition during the curing process.

If coating composition ingredients can be solubilized in an aqueous solution, the solvent is water. Water can be included in an amount up to 30%, by weight, of the composition, and does not introduce a VOC content to the composition. From an environmental and toxicological standpoint, water is a preferred solvent. However, many radiation-curable coating compositions are not amenable to solubilization or dispersion in water. In such cases, an organic solvent can be included in the radiation-curable coating composition.

In general, a suitable organic solvent has sufficient volatility to evaporate essentially entirely from the coating composition during the radiation curing and optional heating steps quickly, essentially entirely, and relatively rapidly to provide a cured coating composition that inhibits the corrosion of a scope line.

Essentially any organic solvent is useful in the present radiation-curable coating composition as long as the organic solvent adequately disperses and/or solubilizes the composition components; is inert with respect to interacting with composition components which adversely affects the stability of the coating composition or the ability of the coating composition to effectively cure. Suitable organic solvents for the UV-curable coating compositions include, but are not limited to, ketones, like acetone, cyclohexanone, methyl ethyl ketone, ethyl aryl ketones, methyl aryl ketones, and methyl isoamyl ketone; aromatic hydrocarbons, like toluene, benzene, and xylene; aliphatic hydrocarbons, like mineral spirits, kerosene, and high flash VM&P naphtha; aprotic solvents, like tetrahydrofuran; chlorinated solvents; esters; glycol ether esters, like propylene glycol monomethyl ether acetate; and mixtures thereof. Preferred organic solvents are VOC-exempt solvents. Most preferred organic solvents comprise acetone, toluene, or a mixture thereof.

An organic solvent is included in the composition in an amount of 0% to about 30%, by weight, of the composition. Typically, a sufficient amount of organic solvent is included in the radiation-curable coating composition to provide a composition that can be processed easily, that can be applied to a metal substrate easily and uniformly, and that is sufficiently removed from the coating composition during cure within the desired cure time. The VOC of the UV-curable coating composition, therefore, is maintained as low as possible, and down to 0% VOC in cases wherein no solvent is used or wherein the solvent is water.

A radiation-curable coating composition is prepared by simply admixing composition ingredients in any desired order, in the optional solvent, with sufficient agitation. The resulting mixture is admixed until all the composition ingredients are homogeneously solubilized or dispersed. If necessary, an additional amount of the optional solvent can be added to the radiation-curable coating composition to adjust the viscosity of the composition to a predetermined level.

As previously discussed, an easily openable can end is prepared from a metal form having the desired shape and dimensions punched from a sheet of metal substrate. A score line is made in the metal form along a line that defines the eventual opening in the can end. Typically, a rivet is formed within opening portion of the can end, and a pull tab for easy opening is fixed by the rivet. The pull tab and rivet are attached to the easily openable can end prior to application of the score line repair coating.

The metal substrate of the can end can be any metal typically used in the manufacture of metal containers. Nonlimiting examples of metal substrates are aluminum, tin-free steel, tinplate, steel, zinc-plated steel, zinc alloy-plated steel, lead-plated steel, lead alloy-plated steel, aluminum-plated steel, aluminum alloy-plated steel, and stainless steel aluminum, tin-free steel, tinplate, steel, zinc-plated steel, zinc alloy-plated steel, lead-plated steel, lead alloy-plated steel, aluminum-plated steel, aluminum alloy-plated steel, and stainless steel.

As also previously stated, the score line disrupts the protective coating present on the exterior surface of the can end. If the score line is left unprotected, the exterior surface of the can end is subject to corrosion during processing of a product packaged in the metal container (e.g., during a retort for packaged food products) or during storage of the packaged product. In accordance with an important feature of the present invention, the radiation-curable coating composition is applied along the score line of a can end to impart corrosion resistance to the score line, i.e., is applied as a repair coating to the score line.

The radiation-curable coating composition is applied to the area of the score line of the metal can end. Coating substantial additional portions of the metal can end are unnecessary because the remainder of the can end has a protective coating, and, therefore, application of the radiation-curable coating composition is wasteful and adds unnecessary cost to the manufacturing process. The radiation-curable coating composition is applied by any method known to persons skilled in the art, for example, by spraying, rolling, or daubing. One method of applying a repair coating to a score line is disclosed in WO 93/00173.

To demonstrate the unexpected benefits provided by applying a radiation-curable coating composition to the score line of a can end, the following UV-curable composition was prepared, then applied to the score line of a metal can end. The resulting metal can ends then were tested for corrosion resistance, and compared to can ends coated with a present-day commercial repair coating. The following example and test results illustrate some important features and embodiments of the present invention, and illustrate improved methods of imparting corrosion resistance to the score line of an easily openable metal can end.

EXAMPLE 1

| Ingredient | Weight % |
|---|---|
| CYRACURE ® UVR-6110 | 74.04 |
| TONE ® POLYOL 0301 | 6.30 |
| TONE ® POLYOL 0310 | 7.30 |
| CYRACURE ® UVI-6990 | 4.40 |
| 1,2-Epoxydecane | 2.90 |
| n-Butanol | 4.70 |
| DC-57 silicone | 0.30 |
| Silicone surfactant¹⁾ | 0.05 |
| Optical brightener²⁾ | 0.01 |
| Total | 100.00 |

¹⁾CoatOSil ® 3500, available from Eastech Chemicals, Inc. Philadelphia, PA; and
²⁾UVITEX ® OB, available from Ciba Specialty Chemicals, Tarrytown, NY.

EXAMPLE 2

| Ingredient | Weight % |
|---|---|
| Example 1 | 80 |
| Acetone | 20 |
| Total | 100 |

As previously stated, can end manufacturers have applied a wax-based repair coating to the score line of easily openable can ends. The repair coating serves to protect the score line from rusting and other forms of visible corrosion due to the reaction of the exposed metal with ambient oxygen and moisture. These conditions are encountered during storage, and especially during water/steam retort sanitation cycles.

Wax-based repair coatings generally do not provided adequate corrosion protection during water retort cycles, which results in an observable rusting around the score line following water processing. This corrosion leads to complaints, and returned can ends, by customers. Although this corrosion is merely an esthetic defect, the corrosion limits the number of ends a manufacturer can manufacture and sell because not all customers accept ends of this quality.

The radiation-curable coating compositions disclosed herein provides substantially improved corrosion resistance along the score line, and conforms to strict VOC emission standards present in many manufacturing plants. A present radiation-curable coating composition contains no reportable VOC in many embodiments, and a low reportable VOC (i.e., 30% or less) in other embodiments. A radiation-curable coating composition can be applied to the score line in a spray-type application, and is cured using UV, e-beam, or IR radiation and an optional heating step. The heating step is used to ensure completeness of the curing reactions, reduce or eliminate the amount of potential extractables in the cured coating composition, and to improve adhesion of the repair coating to the metal can end.

In the present process using UV radiation, a dose of UV radiation is administered after application of the UV-curable coating composition and prior to the optional heating step. In particular, after application of the UV-curable coating composition, the coated can end advances to a UV zone of the manufacturing line, wherein a dose of UV radiation is applied to the can end to cure the UV-curable coating composition.

The can end is subjected to a sufficient dose of radiation intensity to cure the radiation-curable coating composition to a tack-free state, for example, about 50 to about 300 millijoules/cm², preferably about 100 to about 250 millijoules/cm², and to achieve the full advantage of the present invention, about 125 to about 200 millijoules/cm².

In this embodiment, the radiation dose generally is administered using a UV lamp with an intensity of about 100 to about 700 watts per inch (W/in), preferably about 400 to about 600 W/in, for 0.1 seconds to 60 minutes, with the distance between the UV lamp and the can end preferably being about 2 to about 10 centimeters. UV radiation can be conducted under vacuum, in the presence of an inorganic gas, such as nitrogen, argon, helium, and the like, or in air. Suitable UV sources include a UV flood system from Starna or a Solartell Solarscope, Model 1, with a multidirectional probe.

After the TV curing step, the easily openable can end optionally is subjected to a heating step of about 150° F. (65° C.) to about 400° F. (205° C.) for about 1 to about 5 minutes.

Tests were conducted to illustrate the ability of a UV-curable coating composition to impart corrosion resistance to easily openable can ends. The composition of Example 1 or 2 was applied to the score line of a metal can end, followed by curing using two 600-watt/inch UV bulbs. The coated score line was directly exposed to UV radiation during the curing step. The curing step also included an optional thermal treatment after exposure to UV radiation.

In an initial test, the composition of Example 1, having a viscosity of about 40 seconds (#4 Ford Cup), was applied to easily openable can ends on a commercial press. Five minutes after application, the can ends were visually observed to determine whether a sufficient amount of Example 1 was applied to the can ends. In this initial test, it was determined that about 50% of the score line was coated. Even though the amount of Example 1 on the score line was not optimized, the coated can ends were subjected to a dose of UV radiation to cure the composition. It was found that the UV-curable coating composition was adequately cured by the UV radiation dose afforded by two 600-watt/in bulbs after 2 to 5 seconds.

In order to improve the flow and application of the UV-curable coating composition to the score line, the composition of Example 1 was heated to about 90° F. (32° C.) to about 100° F. (38° C.) prior to application to the score line. The viscosity of the heated Example 1 was about 25 seconds (#4 Ford Cup). Application of the heated composition to the score line of the metal can ends significantly improved coverage of the score line.

From these initial tests it was determined that, to achieve sufficient coverage of the score line, the radiation-curable coating composition has a viscosity of about 10 to about 35, and preferably about 10 to about 30, seconds (#4 Ford Cup). To achieve the full advantage of the present invention, the radiation-curable coating composition has a viscosity of about 10 to about 25 seconds (#4 Ford Cup). The desired viscosity can be achieved by a judicious selection of composition ingredients for a 0% VOC composition, by incorporating up to about 30%, by weight, of a solvent into the composition, and/or by heating the radiation-curable coating composition prior to application to the score line.

In another test, several can ends were coated using the heated composition of Example 1. These can ends then were subjected to a dose of UV radiation. A portion of these can ends also were heated at 250° F. (121° C.) to 275° F. (135° C.) for three minutes. The score line coverage of all ends was compared to can ends having a commercial wax-based repair coating. All can ends were soaked in an aqueous copper sulfate solution for 30 seconds, then examined for score line corrosion.

The can ends coated with Example 1 had an average score line coverage of about 80%. Surprisingly, the production control ends displayed an average coverage of 0%, indicating complete score line failure.

In addition to the copper sulfate test, some of the can ends subjected to a heating step were “opened” and analyzed for a tendency to feather or hair. Production-coated ends using a wax-based repair coating were used as the control. This test showed that the ends coated with Example 1 showed very little to no feathering and/or hairing, whereas the control ends displayed slight feathering and slight hairing.

Another series of tests was performed using the composition of Example 2. The composition of Example 2 has a viscosity of 11 seconds (#4 Ford Cup) and contains 20% VOC, i.e., acetone.

The composition of Example 2, unheated, was applied to the score line of metal ends on a commercial press. The score lines had a 93% to 95% coverage. The sole area of the score line that was not well covered was the region where the score line was physically blocked by the pull tab of the easily openable can end.

The can ends (about 50 to 75) coated with the composition of Example 2 were UV cured. After UV curing, the UV-curable coating composition applied to the score line was tack free. A portion of the UV-cured can ends were subjected to a heating step at 250° F. (121° C.) to 275° F. (135° C.) for three minutes. A second portion of the cured can ends were heated at about 150° F. (65° C.) for about 90 seconds. The third portion of the cured can ends were not subjected to a thermal heating step.

In another test, the compositions of Examples 1 and 2 were applied to the score line of easily openable can ends, then UV cured. A portion of the can ends also were subjected to a heating step after UV curing, i.e., heating at 250° F. (121° C.) to 300° F. (149° C.) for about three minutes. Another portion of the UV-cured can ends were subjected to a standard baking ladder in a gas forced draft oven. A three-minute baking time was used for each bake. Baking in this oven was performed at peak metal temperatures (PMT) of 250° F. (121° C.), 300° F. (149° C.), 350° F. (177° C.), and 400° F. (204° C.). Three ends were baked at one time. Using this oven, the ends were expected to be at the target PMT for about 60 to about 90 seconds.

The following tests then were performed on the UV-cured, heat-treated can ends:

Application Coverage: This is defined as the percent of the score line effectively covered by the coating composition. Application coverage is measured by immersing a coated end in a solution of copper sulfate to highlight uncovered areas. The rating scale is 0-100%, with 100% equating to no visible corrosion. This coverage was measured on a set of ends that were exposed to the UV cure step only.

Retort Coverage: This is defined as the percent of the score line that remains effectively covered following a 90-minute, 250° F. (121° C.) water retort step. After retort, the coated end is immersed in a solution of copper sulfate for 30 seconds to highlight any uncovered areas. The rating scale is 0-100%, with 100% equating to no visible corrosion.

Adhesion: This is a measure of the adhesion of the score repair coating to the score line and/or end exterior coating. The adhesion is measured prior to and following a 90-minute, 250° F. (121° C.) water retort step using SCOTCH® #610 tape. The rating scale is 0-100%, with 100% equating to no visible adhesion loss.

Blush Resistance: This is defined as the resistance of the score line repair coating from developing visible blushing in a 90-minute water or steam retort. The rating scale is 0-100%, with 100% equating to no visible blushing.

Gasket Damage: This is a measurement of whether the heating step caused visible damage (e.g., blistering or burning) to the interior gasket of a metal container. For any samples where damage was observed, a description of the damage is noted, e.g., “Blistering,” appears in the appropriate column of Table 1.

TABLE 1

| | Control¹⁾ | Example 1 | | | | | |
|---|---|---|---|---|---|---|---|
| | Prod. Control | Commercial²⁾ | Commercial | Lab²⁾ | Lab | Lab | Lab |
| Thermal Step: | None | No heating | 3′, 250° F.³⁾ | 3′, 250° F. | 3′, 300° F. | 3′, 350° F. | 3′, 400° F. |
| Initial Coverage: | | | | | | | |
| Range⁴⁾ | 0-60.0% | 0.0-20% | | | | | |
| Average⁴⁾ | 29.0% (AVG.) | 13.30% | | | | | |
| Retort Coverage: | | | | | | | |
| Range⁵⁾ | 0.00% | 65-70% | 70.0-80.0% | 0-85.0% | 0-70.0% | 40.0-70.0% | 5.0-80.0% |
| Average⁵⁾ | 0% (AVG.) | 67.00% | 75.00% | 48.30% | 43.30% | 57.00% | 53.30% |
| Overall Range⁶⁾ | 0.00% | 0.0-85.0% | | | | | |
| Overall Average⁶⁾ | 0.00% | 53.00% | | | | | |
| Adhesion | | | | | | | |
| Before Retort | N/A | 100% | 100% | 100% | 100% | 100% | 100% |
| After Retort | N/A | 100% | 100% | 100% | 100% | 100% | 100% |
| Blush Resistance | | | | | | | |
| Steam Phase | N/A | 100% | 100% | 100% | 100% | 100% | 100% |
| Water Phase | N/A | 100% | 100% | 100% | 100% | 100% | 100% |
| Gasket Damage | NONE | NONE | NONE | NONE | NONE | NONE | NONE |

¹⁾Control composition is a commercial wax-based repair coating;
²⁾Can ends cured under commercial or laboratory conditions;
³⁾Heating conditions after UV cure;
⁴⁾Values for 5 or 6 replicate tests;
⁵⁾Values for 3 or 4 replicate tests; and
⁶⁾Post-baked can ends.

TABLE 1

| | Example 2 | | | | | | |
|---|---|---|---|---|---|---|---|
| | Commercial²⁾ | | Commercial | Lab²⁾ | Lab | Lab | Lab |
| Thermal Step: | No heating | Commercial | 3′, 250° F. | 3′, 250° F. | 3′, 300° F. | 3′, 350° F. | 3′, 400° F. |
| Initial Coverage: | | | | | | | |
| Range⁴⁾ | 65.0-85.0% | | | | | | |
| Average⁴⁾ | 75.80% | | | | | | |
| Retort Coverage: | | | | | | | |
| Range⁵⁾ | 0.0-40.0% | 40.0-60.0% | 90.0-95.0% | 65.0-85.0% | 80.0-95.0% | 50.0-95.0% | 75.0-95.0% |
| Average⁵⁾ | 23.30% | 48.30% | 93.30% | 72.00% | 87.00% | 80.00% | 88.30% |
| Overall Range⁶⁾ | 40.0-95.0% | | | | | | |
| Overall Average⁶⁾ | 78.00% | | | | | | |
| Adhesion | | | | | | | |
| Before Retort | 100% | 100% | 100% | 100% | 100% | 100% | 100% |
| After Retort | 100% | 100% | 100% | 100% | 100% | 100% | 100% |
| Blush Resistance | | | | | | | |
| Steam Phase | 100% | 100% | 100% | 100% | 100% | 100% | 100% |
| Water Phase | 100% | 100% | 100% | 100% | 100% | 100% | 100% |
| Gasket Damage | NONE | NONE | NONE | NONE | NONE | NONE | NONE |

Tests using a commercial, wax-based repair coating showed that coverage of the score line with this control composition was sporadic, as shown in the initial coverage of the score line on “production” ends ranged from about 0-60%. Not one of the control ends surveyed was found to provide 100% score line coverage.

In addition to the initial coverage measurement, several control ends were subjected to a 90-minute, 250° F. (121° C.) water retort (50% of the end in the vapor (steam) phase and 50% of the end submerged in the liquid phase). Following retort, the ends were exposed to a copper sulfate solution for 30 seconds, and the score line coverage was measured. In this test, it was found that these control ends did not provide any observable degree of corrosion protection. All of the retorted control ends showed complete failure, i.e., all of the ends were rated as “0%,” indicating that the level of corrosion protection was zero. Because the wax-based repair coating was completely removed from the ends during retort, assessments of blush and adhesion performance were not possible.

Similar tests were performed on the ends that were coated with the composition of Example 1. For Example 1, the initial coverage was evaluated after UV cure only. In this test, the average initial coverage was about 14%. The low initial coverage value is attributed to an inconsistent application coverage with Example 1. This conclusion is substantiated by the application behavior of Example 1 observed in preliminary tests and the observation that many of the retorted ends showed significantly better initial coverage. The improved results observed with these retorted ends indicates better coverage than those examined for the “initial coverage” testing.

This set of can ends also was evaluated using thermal postbakes of 3 minutes at 250° F., 300° F., 350° F., and 400° F. When evaluated for retort performance, these can ends showed significantly better corrosion protection than the control ends. The average coverage of postbaked samples was 53.0%. These results indicate that the initial application coverage is the controlling factor in determining the retort performance, not the optional heating step. No blushing or adhesion loss was noted following retort for any of the postbaked can ends.

In summary, it was found that the composition of Example 1, after UV cure, performs acceptably for retort corrosion, adhesion, and blush resistance using the postbakes evaluated. However, its application to the can end was somewhat deficient because of the viscosity of the composition.

Similar tests were performed on can ends coated with composition of Example 2. Example 2 showed significantly better initial coverage than the composition of Example 1. The average initial coverage for Example 2 was about 76%, compared to about 14% for Example 1. The composition of Example 2 offered improved flow through the feed lines and applicator, which improved the on-line application coverage.

Retort testing also was performed on can ends coated with the composition of Example 2. The same postbake conditions used for can ends coated with Example 1 were used for can ends coated with Example 2. However, the use of a “compound oven” also was used as a postbake alternative. As in the case with Example 1, there was little differentiation among the postbaked can ends. All of the heated can ends tested provided adequate adhesion and blush resistance. Overall, the corrosion protection of ends coated with Example 2 was significantly improved over can ends coated with Example 1. The postbaked ends showed an average corrosion protection after retort of about 78% for Example 2 compared to about 53% for Example 1. This indicates a much more consistent, uniform initial coverage of the score line by the composition of Example 2. Many of the retorted ends in this set of can ends exhibited a corrosion failure of only about 5% to 15%. This failure was confined essentially to the area of the score line that is physically blocked from good contact with the repair coating by the pull tab.

Therefore, it has been found that a UV-curing coating composition outperforms present-day repair coatings for the score line of an easily openable can end. In particular, a wax-based repair coating performed poorly following retort testing and showed essentially 100% failure. Can ends coated with the composition of Example 1 provided significantly better retort corrosion protection than the control repair coating. It also was found that, in the areas where the composition of Example 1 were initially applied, adequate blush and corrosion resistance was provided. The composition of Example 2 provided significantly improved application properties and resulted in more effective score line protection during water retorting.

In addition, the interior gasket material was not sensitive to the optional heating step because no visual damage to the gasket of a metal container was observed for any of the heated can ends.

Radiation-curable coating compositions also can be cured by e-beam or infrared radiation. In these embodiments, the amount of e-beam or infrared radiation applied to the radiation-curable coating composition essentially is equivalent to the amount of UV radiation applied to a UV-curable composition. For IR-curable coating compositions, the photoinitiator preferably is a thermally-blocked acid initiator.

Modifications and variations of the invention as hereinbefore set forth can be made without departing from the spirit and scope thereof, and, therefore, only such limitations should be imposed as are indicated by the appended claims.

1. A method of imparting corrosion resistance to a score line of an easily openable metal can end comprising the steps of:
(a) providing a metal can end having a score line;
(b) applying a layer of a radiation-curable coating composition to the score line to provide a coated metal can end, said radiation-curable coating composition comprising:
(i) a difunctional compound,
(ii) a polyfunctional reactive diluent,
(iii) a cationic photoinitiator, and
(iv) up to about 12%, by weight, of a monofunctional reactive diluent; and
(c) exposing the coated metal can end to a sufficient dose of radiation to cure the radiation-curable coating composition and form a cured coating composition on the score line.

2. The method of claim 1 further comprising the step of:
(d) heating the coated metal can end resulting from step (c) for about one to about five minutes at about 65° C. to about 205° C. for about one to about five minutes.

3. The method of claim 1 wherein the metal can end is manufactured from a metal selected from the group consisting of aluminum, tin-free steel, tinplate, steel, zinc-plated steel, zinc alloy-plated steel, lead-plated steel, lead alloy-plated steel, aluminum-plated steel, aluminum alloy-plated steel, and stainless steel.

4. The method of claim 1 wherein the radiation-curable coating composition further comprises up to about 30% of a solvent selected from the group consisting of water, an organic solvent, or a mixture thereof.

5. The method of claim 1 wherein the radiation-curable coating composition comprises about 60% to about 85%, by weight, of the difunctional compound.

6. The method of claim 1 wherein the radiation-curable coating composition comprises about 10% to about 20%, by weight, of the polyfunctional reactive diluent.

7. The method of claim 1 wherein the radiation-curable coating composition comprises about 2% to about 8%, by weight, of the photoinitiator.

8. The method of claim 1 wherein the difunctional compound is selected from the group consisting of a diepoxy compound, a vinyl epoxy compound, a divinyl compound, or a mixture thereof.

9. The method of claim 8 wherein the diepoxy compound comprises a cycloaliphatic diepoxy compound.

10. The method of claim 9 wherein the cycloaliphatic diepoxy compound is selected from the group consisting of 3,4-epoxycyclohexylmethyl-3,4-epoxycyclohexane carboxylate, bis(3,4-epoxycyclohexyl)-methyl adipate, 2-(3,4-epoxycyclohexyl-5.5-spiro-3,4-epoxy)cyclohexane-metal-dioxane, 1,6-hexanediol diglycidyl ether, dipropylene glycol diglycidyl ether, diglycidyl ether of polypropylene glycol, ethylene glycol diglycidyl ether, a diglycidyl ether of phthalic acid, a diglycidyl ether of hexahydrophthalic acid, propylene glycol dioleate epoxide, limonene dioxide, a cresol-novolac diepoxy compound, 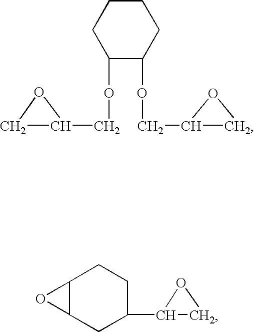
and mixtures thereof.

11. The method of claim 8 wherein the vinyl epoxy compound has a structure 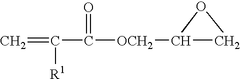
wherein R¹ is hydrogen or methyl.

12. The method of claim 8 wherein the vinyl epoxy compound is selected from the group consisting of glycidyl methacrylate, glycidyl acrylate, mono- and diglycidyl itaconate, mono- and diglycidyl maleate, mono- and diglycidyl fumarate, that allyl glycidyl ether, vinyl glycidyl ether, and mixtures thereof.

13. The method of claim 8 wherein the divinyl compound is selected from the group consisting of divinyl ether, diethylene glycol divinyl ether, 1,4-butanediol divinyl ether, triethylene glycol divinyl ether, and 1,4-cyclohexanedimethanol divinyl ether.

14. The method of claim 1 wherein the polyfunctional reactive diluent is selected from the group consisting of an ε-caprolactone triol, glycerol, a polyether polyol, a polyester polyol, 1,2,6-hexanetriol, pentaerythritol, and mixtures thereof.

15. The method of claim 1 wherein the polyfunctional reactive diluent comprises a hydroxy-terminated polyester.

16. The method of claim 1 wherein the photoinitiator comprises a sulfonium salt, an iodonium salt, a thermally-blocked acid catalyst, or a mixture thereof.

17. The method of claim 1 wherein the photoinitiator comprises (thiodi-4,1-phenylene)bis(diphenyl-sulfonium)hexafluoroantimonate, diphenyl-(4-phenylthiophenyl)sulfonium hexafluoroantimonate, triarylsulfonium hexafluoroantimonate salts, mixed triarylsulfonium hexafluorophosphate salts, bis(4-(diphenylsulfonio)phenyl)sulfide bis(hexafluorophosphate), diphenyl phenylthiophenyl sulfonium hexafluorophosphate, para-toluenesulfonic acid, dinonylnaphthelene disulfonic acid, dinonylnaphthalene monosulfonic acid, dodecylbenzene sulfonic acid, and mixtures thereof.

18. The method of claim 1 wherein the monofunctional reactive diluent comprises an alcohol, a glycol ether, an epoxy compound, or a mixture thereof.

19. The method of claim 18 wherein the epoxy compound comprises an epoxidized C₁₀ to C₃₀ alpha olefin, 1,2-epoxyhexadecane, 1,2-epoxydecane, 1,2-epoxytetradecane, alpha pinene oxide, limonene monoxide, epoxidized polybutane, a cycloaliphatic monoepoxide, and mixtures thereof.

20. The method of claim 19 wherein the alcohol or glycol ether comprises butanol, n-propanol, hexanol, octanol, diacetone alcohol, ethylene glycol monomethyl ether, ethylene glycol monoethyl ether, ethylene glycol monobutyl ether, propylene glycol monomethyl ether, and mixtures thereof.

21. The method of claim 1 wherein the ultraviolet-curable coating composition further comprises at least one of:
up to about 0.5%, by weight, of a silicone surfactant;
up to about 0.05%, by weight, of an optical brightener; and
up to about 2%, by weight, of a slip- and mar-resistance additive.

22. The method of claim 4 wherein the solvent is selected from the group consisting of acetone, cyclohexanone, methyl ethyl ketone, ethyl aryl ketones, methyl aryl ketones, methyl isoamyl ketone, toluene, benzene, xylene, mineral spirits, kerosene, high flash VM&P naphtha, tetrahydrofuran, a chlorinated solvent, propylene glycol monomethyl ether acetate, and mixtures thereof.

23. The method of claim 4 wherein the solvent comprises water.

24. The method of claim 1 wherein the radiation-curable coating composition applied in step (b) has a viscosity of about 10 to about 35 seconds (#4 Ford Cup).

25. The method of claim 1 wherein the coated metal can end in step (b) is subjected to radiation in an amount of about 50 to about 300 millijoules of per square centimeter of the coated metal can end.

26. The method of claim wherein the photoinitiator comprises a cationic photoinitiator and the radiation is ultraviolet or e-beam radiation.

27. The method of claim 1 wherein the photoinitiator comprises a thermally-blocked acid catalyst and the radiation is infrared radiation.

28. An easily openable can end prepared by the method of claim 1.

29. An easily openable can end having a score line coated with a radiation cured coating of claim 1.

30. A metal container having an easily openable can end prepared by the method of claim 1.
